(19) United States
(12) Patent Application Publication
(10) Pub. No.: US 2006/0143037 A1
(43) Pub. Date: Jun. 29, 2006

(54) System for taking over and operating services and installations at a site

(75) Inventors: Serge Artiguenave, Andilly (FR); Yanick Bertrand, Chanteloup Vignes (FR); Luc Chilou, Saint Aubin Du Corniel (FR); Philippe Manguine, Ruc Trempasse (FR); Francois Vidal, Paris (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ELYO

(21) Appl. No.: 11/153,996

(22) Filed: Jun. 16, 2005

Related U.S. Application Data
(63) Continuation of application No. PCT/FR03/03666, filed on Dec. 10, 2003.

(30) Foreign Application Priority Data
Dec. 20, 2002 (FR) 0216423

(51) Int. Cl. G06Q 99/00

(52) U.S. Cl. 705/1

(57) ABSTRACT

The system for taking over and operating services and installations at a site comprise portable means for collecting data at the site and a central unit comprising a module for analyzing the services and technical installations of the site, a computer-assisted maintenance manager module, and a module for following up and optimizing operation and maintenance of the site, said module analyzing maintenance and breakdowns in order to modify the classification of the corresponding equipment in the analysis module and in order to modify the corresponding maintenance schedules in the maintenance manager module.

The invention relates essentially to the services and installations at a site, e.g. an industrial, commercial, or public site, and more particularly it relates to a system for taking them over and for operating them.

### BACKGROUND OF THE INVENTION

More and more frequently, businesses and organizations whether industrial, commercial, public, or private, are entrusting the maintenance and the operation of all of the installations and services at a site to a service provider who needs to be capable, in a very short length of time, to take over the operation thereof and to continuously improve the reliability levels thereof.

To do this, the service provider presently has known means available for analyzing the services and installations of a site, and computer-assisted maintenance management (CAMM) systems that enable maintenance operations to be planned and followed up.

On a case-by-case basis, while operation is taking place, the service provider can change the maintenance schedules as drawn up by the CAMM system and its operating procedures, in order to take account of feedback from experience or of modifications to the installations of the site.

Specifically, for the purpose of taking over services and installations at a site, tools are known for taking a census of the equipment so as to draw up an inventory of the installations, and possibly also classify them in terms of processes, technologies, geographical zones, or functions, where such classification can be based on a tree structure used in the CAMM system.

Tools are also known for analyzing risk, which tools enable equipment to be sorted into a hierarchy depending on degree of importance in a production process, for example a risk analysis tool of the hazard and operatability (HAZOP) type.

Tools are also available for analyzing the performance and the state of equipment, as are tools for establishing preventative maintenance schedules, which tools make use of the risk analysis tools in order to define or adapt maintenance schedules that are subsequently used in the CAMM system.

At present, it is desired to enable the service provider, on taking over a site, to provide its client with a certain number of elements such as a takeover report, a report on the state of the assets, and a progress and investment plan, and to set up an operating system on the basis of recommendations concerning the organization of the operating team, the maintenance plan, and the operating procedures.

Presently available means do not enable this object to be achieved in realistic time and at realistic cost. Known risk analysis tools are complex to use and are often incompatible with taking over control in a short length of time and within a determined budget, and the inventory of the equipment does not make it possible to obtain the corresponding risk analysis and improvement and progress plan.

Furthermore, it is difficult to take account of an entire site and all of its equipment in its detail and diversity. In addition, known tools relate essentially to maintenance and do not deal with operating the site and with the alterations that need to be carried out. Finally, known CAMM systems do not have a function for varying maintenance schedules to take account of feedback from experience so as to improve the reliability of installations.

### OBJECTS AND SUMMARY OF THE INVENTION

A particular object of the present invention is to provide a solution to this problem that is simple, effective, and inexpensive.

The invention provides a system for taking over and operating the services and technical installations of a site, making it possible firstly to take the site over quickly, and secondly to optimize the operation and maintenance of the technical installations and services of the site.

For this purpose, the invention provides a system for taking over and operating technical installations and services at a site, e.g. an industrial, commercial, or public site, the system comprising:

a central data processor unit having a module for analyzing the technical installations and the services of the site, a computer-assisted maintenance management module, and a module for formatting and transferring data between the analysis module and the maintenance manager module; and

portable means for collecting data by inputting data at the site and transferring said data to the central unit;

the system further comprising:

a module for following up and optimizing operation and maintenance, said module comprising means for analyzing the maintenance that is undertaken and for taking account of the breakdowns that are observed; and

means for exchanging data between said module and the above-mentioned analysis and maintenance manager modules to make corresponding modifications in the analysis module to the classification of the equipment used in the services and technical installations and to make corresponding modifications to the maintenance schedules in the maintenance manager module, and to define technical modifications suitable for making the above-mentioned services and technical installations more reliable as a function of the maintenance that has already been carried out and of the breakdowns that have been observed.

The takeover and operating system of the invention thus differs from the above-mentioned systems of the prior art essentially by taking account of maintenance that has already been performed and by analyzing the breakdowns that have been observed, thereby enabling it to modify accordingly the previous analysis of the equipment concerned and the previous maintenance schedules, thereby improving both operation and maintenance.

In general, in the meaning of the present patent application, a breakdown is a malfunction of a piece of technical equipment or of a service (an expected function is not performed), while maintenance serves to remedy such malfunction.

Maintenance consists in particular in defining tasks, in setting durations for intervention and frequencies for inspection, and in proposing solutions to breakdowns and to operating difficulties.

The solutions proposed cover a very wide variety, and they are always technical in nature, for example changing the type of some particular apparatus, installing it in some other location, fitting it with sensors for detecting variations in parameters and physical magnitudes, replacing such-and-such a component after so many hours of service, etc.

According to another characteristic of the invention, the follow-up and optimization module also comprises means for taking account of equipment added to the site and modifications made to existing equipment.

This enables operation and maintenance procedures to be updated on a continuous basis and produces a corresponding improvement in operation and maintenance.

In more detail, the follow-up and optimization module of the system of the invention comprises means for establishing a history of breakdowns, means for coding breakdowns by their nature, by their severity, and by the equipment to which they correspond, means for calculating a preliminary risk index for each piece of equipment concerned, and means for transmitting these indices to the analysis module.

The follow-up and optimization module is implemented, for example, by using a database of the “ACCESS” type that is suitable for performing the sorting and statistical processing needed for analyzing breakdowns.

The history of breakdowns analyzed for each piece of equipment is taken directly from the database of the CAMM system.

The analysis module of the system of the invention comprises means for collecting and analyzing data, means for taking over the services and installations of the site, means for measuring the state of the assets (services and installations), and means for establishing reports concerning the takeover of the site and concerning the investment plan.

In greater detail, the data analysis means comprise means for breaking down the services and technical installations into systems, each formed by a set of pieces of equipment that are interconnected or that interact, the means for taking over services and technical installations comprise means for establishing a hierarchy between systems, means for breaking systems down into functional groups, each formed by one or more pieces of equipment enabling a determined function to be performed, means for classifying systems by category of importance, and means for determining a takeover type for each system as a function of its importance category, where the various takeover types comprise, for example: visual takeover, functional takeover, and detailed takeover.

The means for taking over services and technical installations also comprise, for each functional group, means for preliminary risk analysis enabling the most sensitive functional group to be identified and for determining the criticality levels of the sensitive functional groups of the most important systems.

In general, an advantage of the present invention is to provide a system that enables maintenance to change over time and that takes account of maintenance that has already been undertaken, the breakdowns observed, the addition of new equipment, and modifications made to existing equipment.

### BRIEF DESCRIPTION OF THE DRAWINGS

The invention will be better understood and other characteristics, details, and advantages thereof will appear more clearly on reading the following description made by way of example and with reference to the accompanying drawings, in which:

FIG. 1 is a diagram of a takeover and operating system of the invention;

FIG. 2 is a flow chart showing the central operations performed by the analysis module of the system of the invention;

FIG. 3 is a flow chart of the essential operations performed by the follow-up and optimization module to take account of breakdowns; and

FIG. 4 is a flow chart of the essential operations performed by the follow-up and optimization module for taking account of new technical equipment installed at the site.

### MORE DETAILED DESCRIPTION

Reference is made initially to FIG. 1 which is a diagram showing the essential components of a system of the invention, the system comprising a central data processor unit 10 installed on the premises of a service provider and which is suitable for connection via a telecommunications network 12, such as the public telephone network, the Internet, etc., to at least one portable appliance 14 for inputting data on site, said appliance 14 being of a type that is available on the market such as those sold under the names NOKIA 9210, PALM PILOT, etc.

The central unit 10 is a data processor unit, typically of the personal computer (PC) type or the like, having installed therein essentially a module 16 for analyzing technical installations and services of a site that is to be taken over, a module 18 for computer-assisted maintenance management (CAMM), a module 20 for formatting and transferring data between the analysis module 16 and the CAMM module 18, and a module 22 for following up and optimizing operation and maintenance, and that is capable of exchanging data with the CAMM module 18 and with the analysis module 16.

The data input by the portable appliance(s) 14 is transmitted to the analysis module 16 and to the follow-up and optimization module 22 as a function of the nature of that data, with the or each appliance 14 serving to create “equipment” files in the central unit 10, to take over said equipment, and to input observations associated with the equipment.

So-called “equipment” files can be created for different premises, each of the files created in this way being attached to functional and geographical tree structures. The file name is created manually by the operator in compliance with predefined formats.

The or each portable appliance 14 also serves to input various criteria for taking over technical equipment and for measuring the state of such equipment.

The data as input is transmitted to the central unit 10 either via the telecommunications network 12 or by connecting the appliance 14 to the central unit.

As shown very diagrammatically in FIG. 1, the data processing performed by the central unit 10 serves firstly to provide the service providers with a certain number of recommendations 24 concerning the organization of the operating team in terms of maintenance and operating procedures, and secondly to establish for the client or the owner of the site, elements 26 that comprise in particular a takeover report comprising proposals for improvements or establishing compliance, a report on the state of the assets, reusing the analysis of the state of the on-site equipment, and a process and investment plan.

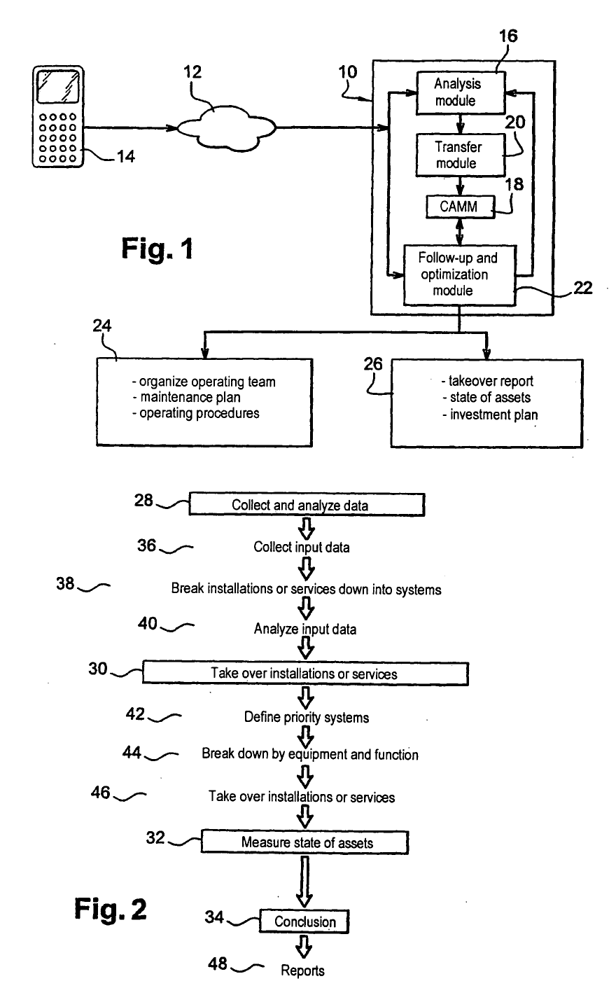

As shown in greater detail in FIG. 2, the analysis module 16 comprises four distinct portions, namely a portion 28 for collecting and analyzing data, a portion 30 for taking over services or technical installations, a portion 32 for measuring the state of the assets, and a portion 34 for establishing conclusions.

The first portion 28 of the analysis module 16 serves to make sure of the presence and of the content of the different types of input data needed in order to draw up a list of questions and/or points to be elucidated, and a list of remarks that can be used directly by the service provider, in order to ensure that at the beginning, when starting the contract, all of the sensitive points and recommendations are available that will need to be taken into account throughout the takeover and operating contract.

In this first portion 28, a first operation 36 relates to collecting input data comprising in particular:

the contract for the services to be provided;

data concerning regulations on various topics such as ventilation, chimney-sweeping, boiler logs, smoke extraction, disconnections, drinking water, electrical installations, electrical transformers, gas detectors, fire safety equipment, elevators, hoists, gas pressure apparatuses, automatic doors, fuel storage, thermal installations, etc.;

the documentation constituted by plans, installation diagrams, location of equipment, operating and maintenance guides provided by suppliers, maintenance plans and schedules, etc.;

subcontractor contracts relating to open spaces, to cleaning, to maintaining electricity generator units, etc.; and

“client” procedures such as purchasing spare parts, putting spare parts into stock and extracting them from stock, histories of equipment damage and failures, follow-up of performance indicators, the use of CAMM, access to premises, authorization and qualification of the parties involved, mail distribution circuits, management of reproduction priorities, use of the telephone exchange, etc.

The following step 38 consists in breaking down the installation or services of the site into systems that are determined sets of interconnected or interacting pieces of equipment, each system thus corresponding to a piece of equipment or a set of equipment for performing a main function of a technical installation or a service (for example the electrical power supply system of a building, the air conditioning system of a computer room, a mail sorting system, a mail delivery system, etc.).

In this step, it is appropriate also to indicate for each system which building or location is served at the site.

The result of this step 38 is a table comprising the set of associated systems for the technical installation or service under consideration.

The following step 40 comprises analyzing input data as collected in step 36, this step 40 serving to draw up a list of questions and points to be elucidated, and also a list of recommendations that can be used directly by the service provider.

The second portion 30 essentially comprises an operation 42 of defining priority systems, i.e. putting systems into a hierarchy, an operation 44 of breaking down systems into functional groups, and an operation 46 of defining the level at which installations or services are taken over.

The purpose of step 42 is to classify all of the systems in a plurality of categories, e.g. three categories such as: systems that are very important; systems that are important; and systems that are not important; with each category being associated with a different takeover level.

To do this, each system is evaluated as a function of a plurality of criteria such as safety, hygiene, and the environment, technical control, general state and organization, impact of losing the function or the service.

For example, three values can be given to each criterion:

the safety, hygiene, and environment risk can be low, high, or very high;

technical control of the function provided by the system may take three different values depending on whether the function is known and controlled by the person in charge of the site, or whether the function is judged to be complex or not well known to that person;

the general state of the equipment or the organization can be good, medium, or poor; and

the impact of losing the function or the service may be low, medium, or high.

From the values given to those criteria, it is possible to establish the level of importance of each system, for example by defining its level of importance as a sum of powers of ten having exponents defined by the values given to the criteria.

If the responses are: level 2 for the safety, hygiene, and environment risk; level 1 for technical control; level 1 for general state; and level 3 for impact; then the level of importance I is equal to 10²+10¹+10¹+10³, i.e. 1120.

By an a priori classification, it is possible to say that a system is very important if its level of importance I is greater than 1030, and that the system is not important if its level of importance I is less than 220.

The following step 44 consists in breaking down the systems defined in the preceding step into functional groups, each functional group being a piece of equipment or a set of equipment that enables a given function to be performed.

To achieve this breakdown, it is possible to use a functional tree structure of known type.

The following step 46 comprises defining the takeover levels of systems, where takeover may be, for example: visual, functional, or detailed.

When a system is very important, takeover should be visual, functional, and detailed. When a system is important, takeover should be visual and functional. Unimportant systems can be taken over visually.

The purpose of taking over visually is to make a qualified inventory of all of the systems. For each functional group, a certain number of elements are input and analyzed, such as the name and the reference of the equipment, its brand, its manufacturer, its type, its characteristics, its year of first use, a rating on a three-level scale as a function of criteria concerning safety, compliance, and general state, additional observations, actions that are envisaged, an indication of the corresponding sector (operation, preventative maintenance, corrective maintenance, work), and the corresponding time periods.

Functional takeover is intended to measure the capacity of installations to respond to expressed requirements or the capacity of services to supply the requested service. This takeover is performed on the functional group associated with the systems that have been defined as being important or very important.

To do this, it is necessary to establish a preliminary risk analysis which consists in identifying the functional groups that are the most sensitive, whose functionality must be verified in comparison with the requirements of the client. The result of this analysis is a list of actions to be carried out per functional group.

To perform this analysis, it is possible for each functional group to determine whether it is likely to lead to the expected performance of the system not being complied with, and if it could have any incidence on the safety of property or people. For each functional group that is considered as being sensitive, various types of action can be provided, such as measuring and noting performance, testing operation, switching between operating modes, testing safety loops, undertaking inspections, making quality measurements, etc.

For each functional group that is identified as being sensitive, detailed takeover consists in determining the components on which precautions must be taken in order to guarantee final delivery. This detailed takeover is undertaken, for example, only on the sensitive functional groups of systems that are very important.

To do this, a detailed analysis is made of the risks, e.g. analysis of the HAZOP type, which consists in analyzing the failure modes of the functional group, the effects, the causes, the detection means, the degrees of severity, the frequency levels, and the criticality criteria, with this criterion being calculated by multiplying together the frequency, the severity, and-the detection.

For causes identified as being critical, risk-reduction actions are defined as are action priorities, the actors concerned, and the deadlines for performing the actions.

The third portion 32 of the analysis module 16 comprises measuring the state of the assets (technical installations and services) in order to establish an optional renewal plan and periodically measure how the state of the assets is changing compared with a possible action plan.

This operation may be performed only on functional groups that are considered as being sensitive or as having a visual takeover criterion that is listed as “poor”.

For each of the functional groups, a level is defined on a scale of three levels, for example, depending on performance, replacement, and obsolescence criteria.

The fourth portion 34 of the module 16 serves to draw up conclusions consisting essentially in a step 48 of establishing a takeover report concerning the investment plan and an internal report for the service provider and including the above-mentioned recommendations.

The CAMM module 18 may be of a commercially available type.

The data transfer module 20 serves to export data from the analysis module 16 and format it as a function of the CAMM system used. The data may be grouped into three sectors: geographical, functional, and technical.

The data in the geographical sector corresponds to the tree structure and serves to describe the site and to locate its installations.

The data in the functional sector is derived from the functional tree structure used by the service provider and serves to associate the installations with a typical technical organization. It is imported into the fields of the CAMM module 18 for subsequent use as selection, grouping, or comparison criteria when performing analyses.

The technical sector data corresponds to existing technical installations at the site and is associated with the two above-described tree structures.

When data is imported into the CAMM system 18, each piece of equipment is associated with a maintenance plan. To do this, existing models of maintenance schedules are used and personalized as a function of actions defined above, where such personalization can take place at several levels:

task definition;

intervention duration; and

inspection frequency.

The module 22 for following up and optimizing operation and maintenance comprises means for analyzing curative maintenance and means for taking account of equipment that has been added or modified.

As shown diagrammatically in FIG. 3, these means comprise means 50 for establishing a history of breakdowns, this history being extracted directly from the database of the CAMM module 18.

Each breakdown is associated with a functional group and is encoded in application of various criteria, e.g.:

type of stoppage: total, partial, or none;

defect: permanent or intermittent;

defect: internal or external relative to the functional group;

origin of defect: mechanical, electrical,

type of defect: vibration, breakage, leakage, etc.;

severity: prolonged inconvenience, short inconvenience, or no inconvenience to users.

Each maintenance operation extracted from the module 18 can also include the report from the technician who performed the maintenance, the type of intervention performed, and the dates on which the intervention started and ended.

The follow-up and optimization module further comprises means 52 for analyzing breakdowns to calculate for each breakdown criteria of severity and recurrence enabling the preliminary risk index of a functional group to be redefined. Severity is defined as mentioned above (no inconvenience, short inconvenience, or prolonged inconvenience), and recurrence is calculated on the basis of the number of breakdowns associated with a given code for a given functional group. The product of these two criteria of severity and recurrence when multiplied together defines the criticality of each breakdown. The sum of the criticalities of the breakdowns associated with a functional group serve to define the preliminary risk index for that functional group.

This breakdown analysis makes it possible for each functional group to define a preliminary risk index that is updated on each use of the follow-up and optimization module 22.

Combining this preliminary risk index, the sensitivity of the functional group, and the importance of the corresponding system makes it possible to identify those functional groups that must be processed and analyzed on a priority basis, and to sort them and classify them by index.

In the event of a modification, updating the preliminary risk analysis leads to functional takeover and possibly to detailed takeover if the functional group is part of a system that is very important. In addition, the performance criterion of the state measurement will itself be affected by such breakdowns.

As shown diagrammatically at 54, 56, and 58 in FIG. 3, a change in the criticality of the functional group FG can lead either to an archiving operation if there is no change, or to a modification to the maintenance programs and the data of the analysis module.

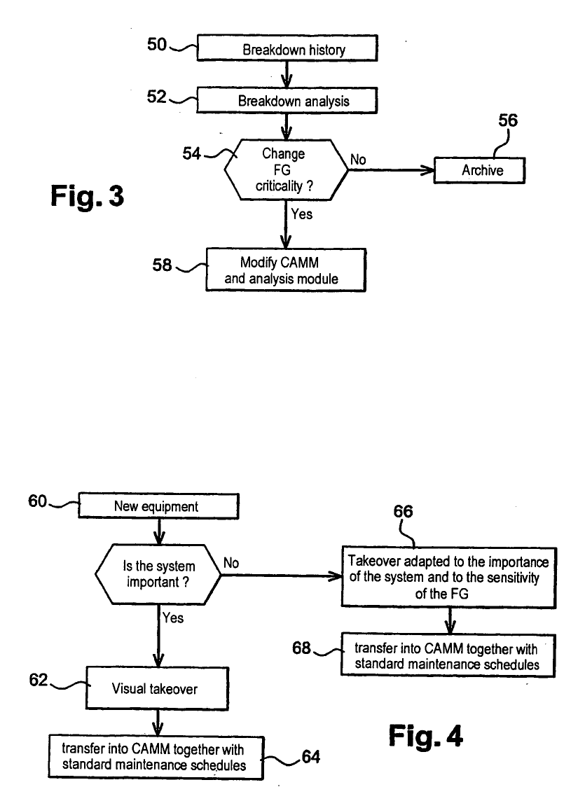

As shown diagrammatically in FIG. 4, the follow-up and optimization module 22 also has means for taking account of new equipment being installed or of a modification to equipment that is already installed.

The installation of new equipment and the modification of existing equipment can be the result either of the installations on site being extended, or of a problem in the operation or the maintenance of existing installations that has been observed by the system of the invention and that has been remedied by installing additional equipment or by modifying existing equipment.

These solutions to problems of operation or maintenance can consist, in specific circumstances, in installing an additional pump, in installing an extractor fan in order to avoid a sudden rise in temperature in premises for uninterruptible power supplies, in installing an outdoor temperature sensor, in fitting pressure gauges if there is a problem in balancing pressures in industrial water networks, in repositioning opening controls, in dismantling a piece of equipment and reassembling it in isolated premises, etc.

When new equipment is installed 60, all of the analysis operations shown in FIG. 2 are performed in order to determine the influence of the new equipment on the importance of the system or on the sensitivity of a functional group.

If the system is not important or if the functional group is not sensitive, it is associated with visual takeover as shown at 62, and the corresponding data is transferred into the CAMM module 18 with a standard maintenance schedule.

If the system is important or if the functional group is sensitive, then as shown at 66, takeover is adapted to its importance or its sensitivity and the corresponding data is transferred at 68 into the CAMM module together with an appropriate maintenance schedule.

The same procedures apply when existing equipment is modified.

What is claimed is:

1. A system for taking over and operating technical installations and services at a site, e.g. an industrial, commercial, or public site, the system comprising:
a central data processor unit having a module for analyzing the technical installations and the services of the site, a computer-assisted maintenance management module, and a module for formatting and transferring data between the analysis module and the maintenance manager module; and
portable means for collecting data by inputting data at the site and transferring said data to the central unit;
wherein the central unit also comprises a module for following up and optimizing operation and maintenance, the module comprising means for analyzing the maintenance performed and for taking account of breakdowns observed, and means for transmitting data between said module and the above-mentioned modules for analysis and managing maintenance, to make a corresponding modification in the analysis module to the classification of the equipment used in the services and the technical installations, and to modify correspondingly the maintenance schedules in the maintenance manager module, and to define technical modifications enabling the above-mentioned services and installations to be made more reliable, as a function of the maintenance already undertaken and the breakdowns observed.

2. A system according to claim 1, wherein the follow-up and optimization module also comprises means for taking account of new equipment being added in the site and of modifications to existing equipment.

3. A system according to claim 1, wherein the data input by the portable data collection means is transmitted to the analysis module and to the follow-up and optimization module.

4. A system according to claim 1, wherein the follow-up and optimization module comprises means for establishing a history of breakdowns, means for encoding breakdowns by their nature, their severity, and the equipment to which they apply, and means for calculating a preliminary risk index for each piece of equipment concerned, classification and sorting means for sorting the equipment by index, and means for transmitting said indices to the analysis module.

5. A system according to claim 1, wherein the analysis module comprises means for collecting and analyzing data, means for taking over the services and technical installations of the site, means for measuring the state of the assets (services and technical installations), and means for establishing reports concerning takeover of the site and concerning an investment plan.

6. A system according to claim 5, wherein the data analysis means comprise means for breaking down the services and technical installations into systems each formed by a set of pieces of equipment that are interconnected or that interact.

7. A system according to claim 6, wherein the means for taking over services and technical installations comprise means for establishing a hierarchy between systems, means for breaking the system down into functional groups each formed by one or more pieces of equipment enabling a given function to be performed, means for classifying systems by categories of importance, and means for determining a type of takeover for each system as a function of its importance category, the different types of takeover comprising, for example, visual takeover, functional takeover, and detailed takeover.

8. A system according to claim 7, wherein the means for taking over services and technical installations also comprise, for each functional group, means for performing preliminary risk analysis, serving to identify the functional groups that are the most sensitive and to determine levels of criticality for the sensitive functional groups of the most important systems.
